(19) United States
(12) Patent Application Publication
(10) Pub. No.: US 2026/0326467 A1
(43) Pub. Date: Oct. 22, 2026

(54) SYSTEMS AND METHODS OF PRINTHEAD SELF-SENSING AND DIAGNOSIS

(71) Applicant: Xerox Corporation, Norwalk, CT (US)

(72) Inventors: Christine A. Steurrys, Williamson, NY (US); Seemit Praharaj, Marlborough, NH (US); Jason M. LeFevre, Penfield, NY (US); Mark C. Petropoulos, Webster, NY (US); Jorge A. Alvarez, Webster, NY (US); Peter M. Gulvin, Webster, NY (US); Anthony S. Condello, Webster, NY (US); Douglas K. Herrmann, Webster, NY (US); Varun Sambhy, Pittsford, NY (US); Brian J. Daniels, Lake Oswego, OR (US)

(73) Assignee: Xerox Corporation, Norwalk, CT (US)

(21) Appl. No.: 19/185,989

(22) Filed: Apr. 22, 2025

(51) Int. Cl. B41J 29/393; B41J 2/045

(52) U.S. Cl. CPC B41J 29/393; B41J 2/0451; B41J 2/04581

(57) ABSTRACT

Provided herein are improved inkjet printing systems and self-diagnostic methods that enable more accurate and efficient identification of inkjet problems. The printing systems according to the present disclosure include one or more piezoelectric printheads, each of which can include hundreds or thousands of individually-controllable inkjets. These printing systems also include an impedance measurement device and are configured to perform a battery of inkjet tests on the piezoelectric inkjets to determine an inkjet status for each of the plurality of piezoelectric inkjets, wherein the battery of inkjet tests includes at least one of: (i) an impedance sweep test, (ii) a purge, wipe, analyze test, and/or (iii) a cap check test.

### FIELD OF THE DISCLOSURE

The present disclosure relates generally to inkjet printing systems, and more specifically to systems and methods for self-sensing and diagnosing inkjet problems in inkjet printheads.

### BACKGROUND

Inkjet printheads, such as piezoelectric printheads, are crucial components of inkjet printing systems and are responsible for transferring ink onto a print media substrate to create text and/or images. These printheads work by ejecting tiny droplets (e.g., on the order of several to tens of picoliters, a picoliter being one trillionth of a liter) through microscopic nozzles, which are arranged in a precise array. Each nozzle is connected to an ink chamber that holds the ink before ejection. A set of actuators are responsible for creating the pressure pulse that forces the ink out of the nozzles. Piezoelectric actuators are common and employ piezoelectric crystals that change shape when an electric charge is applied, thereby creating a pressure pulse.

In operation, an electric charge is applied to the piezoelectric crystal, causing it to flex and create a pressure pulse. This pulse jets a droplet of ink out of the nozzle. When the charge is removed, the crystal returns to its original shape, drawing more ink into the chamber. The printhead is controlled by electronic circuits that manage the timing and sequence of droplet jetting to ensure accurate printing.

A single inkjet printing system may contain one or more distinct printheads, and each printhead may contain hundreds or thousands of individual inkjet nozzles arranged in a compact printing array (e.g., within less than a 2 inch by 6 inch area). One or more printheads may be stationary while the print media substrate moves beneath it, and/or may move across the print media substrate to deposit ink at specific locations and form the desired print.

While advancements in inkjet printhead technologies have enabled significantly improved image generation and faster printing speeds, there are a number of drawbacks to these printing systems. For example, given the scale of the piezoelectric inkjet printheads and the mechanical, electrical, and chemical dynamics involved in ejecting tiny droplets of ink, these printheads exhibit many failure mechanisms which can be exceedingly difficult to detect and diagnose.

### SUMMARY OF THE DISCLOSURE

As described herein, it is appreciated that it would be advantageous to provide systems and methods for improving the detection and diagnoses of inkjet printheads. The embodiments of the present disclosure enable faster, more accurate, and more detailed diagnoses of inkjet printheads, which saves time, improves printing performance, reduces waste by distinguishing between salvageable printheads and those that absolutely need to be replaced. The embodiments of the present disclosure improve upon these and other aspects in the technology.

According to an embodiment of the present disclosure, an inkjet printing system is provided. The inkjet printing system can include: at least one printhead comprising a plurality of piezoelectric inkjets configured to eject ink droplets onto a print media substrate; an impedance measurement device operatively connected to the at least one printhead and configured to measure an impedance response of each piezoelectric inkjet of the plurality of piezoelectric inkjets; and a printer controller operatively connected to the at least one printhead and the impedance measurement device, wherein the printer controller comprises one or more processors in communication with a computer-readable storage medium having stored thereon instructions that, when executed by the one or more processors, cause the inkjet printing system to perform the following operations: perform a battery of inkjet tests on the plurality of piezoelectric inkjets of the at least one printhead to determine an inkjet status for each of the plurality of piezoelectric inkjets, wherein the battery of inkjet tests includes at least one of: (i) an impedance sweep test, (ii) a purge, wipe, analyze test, and/or (iii) a cap check test.

In an aspect, the computer-readable storage medium can include instructions that, when executed by the one or more processors, cause the inkjet printing system to: retrieve a location for each of the plurality of inkjets of the at least one printhead, wherein each location comprises x and y coordinates of the corresponding inkjet; generate, based on the jet status and the location of each of the plurality of inkjets of the at least one printhead, a visual mapping of the inkjet printing system.

In an aspect, the battery of inkjet tests includes the impedance sweep test and the impedance sweep test can include: performing, using the impedance measurement device, an impedance sweep of the plurality of piezoelectric inkjets to collect impedance response data for each piezoelectric inkjet, wherein the impedance sweep of the plurality of piezoelectric inkjets includes measuring an impedance response of each piezoelectric inkjet over a range of frequencies; applying a running average filter over the impedance response data for each piezoelectric inkjet one or more times to generate a filtered impedance response data for each piezoelectric inkjet; identifying, for each piezoelectric inkjet, a local maxima peaks array based on the filtered impedance response data for each corresponding piezoelectric inkjet; determining, for each piezoelectric inkjet, whether the corresponding local maxima peaks array includes a peak located within a predetermined frequency range; and designating the inkjet status of each piezoelectric inkjet having a peak located within the predetermined frequency range as having either a high frequency bubble or a low frequency bubble based on a frequency value of the peak located within the predetermined frequency range.

In an aspect, the inkjet status of a piezoelectric inkjet having a peak located within the predetermined frequency range may be designated as having a high frequency bubble if the frequency value of the peak located within the predetermined frequency range is greater than 500 kHz, and/or the inkjet status of a piezoelectric inkjet having a peak located within the predetermined frequency range may be designated as having a low frequency bubble if the frequency value of the peak located within the predetermined frequency range is less than or equal to 500 kHz.

In an aspect, the local maxima peaks array may be generated, for each piezoelectric inkjet, by: passing a frequency window over the filtered impedance response data; determining a maximum value of the filtered impedance response data within each frequency window; for each frequency window: (i) determining whether each of the corresponding maximum value is located at a beginning or an end of the frequency window; and (ii) if the corresponding maximum value is not located at the beginning or the end of the frequency window, adding a frequency corresponding the maximum value to the local maxima peaks array for the piezoelectric inkjet.

In an aspect, the frequency corresponding to the maximum value is only added to the local maxima peaks array only if the maximum value is greater than an average endpoints value for the corresponding frequency window by a predetermined threshold.

In an aspect, the battery of inkjet tests includes the impedance sweep test and the impedance sweep test can include: performing, using the impedance measurement device, an impedance sweep of the plurality of piezoelectric inkjets to collect impedance response data for each piezoelectric inkjet; applying a running average filter over the impedance response data for each piezoelectric inkjet one or more times to generate a filtered impedance response data for each piezoelectric inkjet; for each piezoelectric inkjet, determining whether a slope of the filtered impedance response data within an initial period is less than a predetermined threshold; and designating the inkjet status of each piezoelectric inkjet having a slope within the initial period that is less than the predetermined threshold as having parallel resistance.

In an aspect, the battery of inkjet tests can include the cap check test, wherein the cap check test includes: performing, using the impedance measurement device, an impedance measurement of each piezoelectric inkjet of the plurality of piezoelectric inkjets at a predetermined frequency to determine an impedance response for each piezoelectric inkjet; designating the inkjet status of each piezoelectric inkjet based on the impedance response of the corresponding piezoelectric inkjet.

In an aspect, the inkjet status of a piezoelectric inkjet can be designated as having a jet-to-ground short if the impedance response of the piezoelectric inkjet is equal to a first predetermined value.

In an aspect, the inkjet status of a piezoelectric inkjet can be designated as having a jet-to-jet short if the impedance response of the piezoelectric inkjet is equal to a second predetermined value, the second predetermined value being different from the first predetermined value.

In an aspect, the inkjet status of a piezoelectric inkjet can be designated as being open if the impedance response of the piezoelectric inkjet is within a predetermined range from zero.

In an aspect, the battery of inkjet tests can include the purge-wipe-analyze test, wherein the purge-wipe-analyze test generates a list of missing inkjets and a list of off-axis inkjets.

In an aspect, the battery of inkjet tests includes: performing the purge-wipe-analyze test to generate a list of missing inkjets and a list of off-axis inkjets; performing the cap check test of a first set of one or more inkjets of the plurality of inkjets to determine an inkjet status for the one or more inkjets of the first set; and performing the impedance sweep test of a second set of one or more inkjets of the plurality of inkjets to determine an inkjet status for the one or more inkjets of the second set.

According to another embodiment of the present disclosure, a method of diagnosing a faulty printhead of an inkjet printing system is provided. The method can include: performing a battery of inkjet tests on a plurality of piezoelectric inkjets of at least one printhead of the inkjet printing system to determine an inkjet status for each of the plurality of piezoelectric inkjets, wherein the battery of inkjet tests includes at least one of: (i) an impedance sweep test, (ii) a purge-wipe-analyze test, and/or (iii) a cap check test; retrieving a location for each of the plurality of inkjets of the at least one printhead, wherein each location comprises x and y coordinates of the corresponding inkjet; and generating, based on the jet status and the location of each of the plurality of inkjets of the at least one printhead, a visual mapping of the inkjet printing system.

In an aspect, the impedance sweep test and the cap check test can be performed by measuring an impedance response of the plurality of inkjets at one or more frequencies using an impedance measurement device operatively connected to the at least one printhead of the inkjet printing system.

In an aspect, the visual mapping identifies a spatial location of the at least one printhead, and the location of each non-functional inkjet of the plurality of inkjets is marked on the visual mapping of the inkjet printing system.

In an aspect, the inkjet status of each non-functional inkjet indicates a failure mode of the non-functional inkjet, and the marking of each non-functional inkjet of the plurality of inkjets on the visual mapping is unique to the indicated failure mode.

In an aspect, the method can further include displaying, on a display device, the visual mapping of the inkjet printing system.

In an aspect, the method can further include automatically generating a recommended remediation based on the visual mapping of the inkjet printing system. A ccording to another embodiment of the present disclosure, a remote management device is provided. The remote management device can be configured to perform printhead self-sensing and diagnosis of one or more remote inkjet printing systems. For example, the remote management device may include one or more processors in communication with a non-transitory computer- readable storage medium having stored thereon instructions that, when executed by the one or more processors, cause the remote management device to perform: (1) connect, via a communication network, with a remotely located inkjet printing system, the inkjet printing system comprising (i) at least one printhead having a plurality of piezoelectric inkjets, and (ii) an impedance measurement device operatively connected to the at least one printhead; (2) instruct the remotely located inkjet printing system to perform a battery of inkjet tests on the plurality of piezoelectric inkjets of the at least one printhead, wherein the battery of inkjet tests includes at least one of: (i) an impedance sweep test, (ii) a purge, wipe, analyze test, and/or (iii) a cap check test; (3) receive, from the remotely located inkjet printing system, test data output based on the battery of inkjet tests; and (4) analyze the test data output to determine an inkjet status for each of the plurality of piezoelectric inkjets.

These and other aspects of the various embodiments will be apparent from and elucidated with reference to the embodiments described hereinafter.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the various embodiments.

FIG. 1 is a block diagram of a high-production, continuous printing system illustrated in accordance with aspects of the present disclosure.

FIG. 2 is a block circuitry diagram of a printhead according to aspects of the disclosure.

FIG. 3A is a block diagram of a printing system according to one embodiment of the present disclosure.

FIG. 3B is a block diagram of a printing system and a remote management device according to another embodiment of the present disclosure.

FIG. 4 is a block diagram of a controller configured to diagnose inkjet printhead problems in accordance with various aspects of the present disclosure.

FIG. 5 is a flowchart illustrating a method of diagnosing inkjet printhead problems in accordance with various aspects of the present disclosure.

FIG. 6 is a flowchart illustrating a method of performing an impedance sweep test of one or more inkjets of a printhead in accordance with aspects of the present disclosure.

FIG. 7 is a graph illustrating certain impedance response data trends that are observable in accordance with aspects of the present disclosure.

FIG. 8 is an illustration of an electronic device showing a visual mapping of a printing system in accordance with aspects of the present disclosure.

FIG. 9 is an enlarged view of the visual mapping shown in FIG. 8.

FIG. 10 is an enlarged view of one printhead shown in the visual mapping of FIG. 9.

FIG. 11 is an enlarged view of another printhead shown in the visual mapping of FIG. 9.

### DETAILED DESCRIPTION OF EMBODIMENTS

The present disclosure is directed to improved inkjet printing systems and self-diagnostic methods that enable more accurate and efficient identification of inkjet problems. In particular, those of ordinary skill in the art will appreciate that inkjet printheads, such as piezoelectric printheads, typically contain hundreds or thousands of individually-addressable inkjets that are meticulously controlled to eject tiny droplets of ink onto a moving print media substrate. Given the scale of the inkjet printheads and the mechanical, electrical, and chemical dynamics involved in ejecting such ink droplets, the inkjets of each printhead exhibit a number of failure mechanisms, many of which can be exceedingly difficult to detect and diagnose. Accordingly, the systems and methods of the present disclosure improve upon these and other aspects of inkjet printing technology.

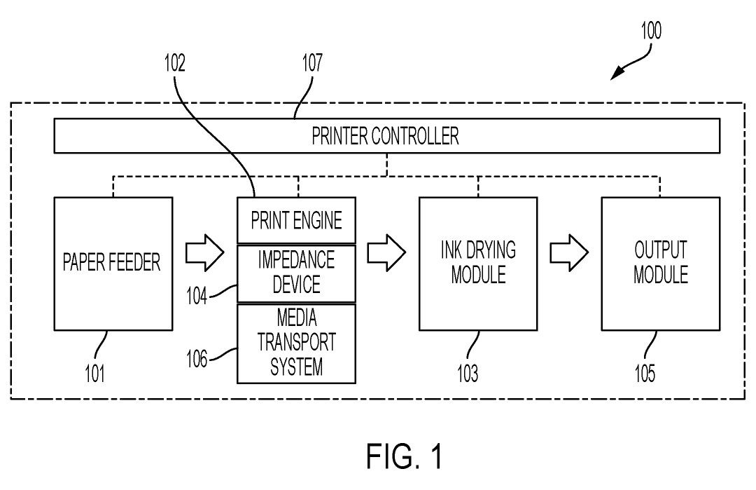

With reference to FIG. 1, a generalized block diagram of a printing system 100 is shown according to aspects of the present disclosure. In embodiments, the inkjet printing system 100 may be a digital printing press, such as a high-performance, cut-sheet inkjet printing system. The printing system 100 may also be a high-volume and high-quality inkjet printing system. In particular embodiments, the printing system 100 may be referred to as a production inkjet (PIJ) system. For example and without limitation, the printing system 100 may be a Xerox Baltoro™ HF Inkjet Press, or a similar printing system. In various embodiments, printing system 100 may also be a multi-function device (MFD), such as a multi-function printer (MFP).

As shown in the example of FIG. 1, the printing system 100 generally includes a cut-sheet paper feeder module 101, a print engine 102, an ink drying module 103, an output module 105, a media transport system 106, and a printer controller 107.

The paper feeder module 101 is configured to store various types of print media and convey the print media to the print engine 102 via the media transport system 106. In embodiments, the paper feeder module 101 can include one or more cassettes or trays and adjustable leveling assemblies configured to move the sheets of print media into proper position when needed for a particular print job. In embodiments, the print media can include, but is not limited to, uncoated plain paper, inkjet treated or inkjet coated paper, offset coated paper, as well as uncoated and/or un-primed paper. In further embodiments, the print media can have different sizes. For example, the feeder module 101 may allow for a maximum media width of approximately 14 inches (inboard-to-outboard direction). However, some print jobs will require media that is less than the full 14 inches wide (e.g., 12 inches for a 12”x18” media is a common size in the print industry). In this narrow media printing scenario, the paper in the printing system 100 is generally outboard registered (i.e., aligned with the outboard edge of the media transport system 106).

The print engine 102 is configured to eject ink droplets from one or more inkjet printheads 200 onto the print media as it passes through a printing zone via the media transport system 106. In embodiments, the print engine 102 comprises one or more print bar assemblies, each print bar assembly comprising a printhead mounting plate and one or more inkjet printheads 200 mounted thereon. The one or more inkjet printheads 200 can be operatively connected to one or more ink reservoirs. Each printhead of the print engine 102 can include a plurality of individual inkjets that can be individually controlled in order to recreate the desired image content of a print job.

In embodiments, each print bar assembly may comprise one or more printheads configured to eject ink droplets of a particular color (e.g., magenta, cyan, yellow, and black) within the printing zone. In specific embodiments, the print engine 102 can include four print bar assemblies, each having three separate inkjet printheads for a total of 12 printheads. In further embodiments, the inkjet printheads may be piezoelectric printheads having hundreds or thousands of individually-addressable piezoelectric inkjets.

The ink drying module 103 is configured to apply heat and/or pressure to the print media to dry the jetted ink and fuse the jetted ink onto the print media. In embodiments, the ink drying module 103 may be referred to as a fuser. The ink drying module 103 can include one or more drying lamps that are used to dry the ink in a “non-contact” manner.

The output module 105 is configured to present the finished print media for retrieval. In embodiments, the output module 105 can include a stacker that stacks the finished print media.

Optionally, the printing system 100 can also include a finishing module (not shown) that is configured to apply various finishing details to a print job. In embodiments, these finishing details can include, for example, stappling, hole punching, binding, lamination, and/or the like, including combinations thereof.

The media transport system 106 generally includes one or more components configured to convey print media from one or more sources (e.g., trays of the feeder module 101) to the print engine 102 and then to an output module 105. In embodiments, the media transport system 106 can include a perforated transport belt disposed on multiple rollers, a vacuum plenum disposed below the transport belt, and a vacuum source configured to apply a vacuum through the vacuum plenum and the perforated transport belt in order to keep print media secured to the transport belt.

As a print media moves in a process direction through a printing zone defined by the print bar assemblies, the printheads 200 are operated to jet ink droplets in a controlled manner to generate an image on the print media.

In embodiments, the printing system 100 and the printer controller 107 may be used to implement a printing path schedule based on one or more print orders. The printing system 100 may be capable of continuous printing as well as simplex and/or duplex output.

As described herein, the printing system 100 can include one or more piezoelectric printheads 200 operatively connected to an impedance measurement device 104 that is configured to measure an impedance of the piezoelectric actuators for each individual inkjet 208. The impedance measurement device 104 may be a separate device or may be integrated into the printheads as described in U.S. Patent No. 10,500,846 B1, the content of which is incorporated by reference in its entirety.

As described, piezoelectric inkjet printheads 200 generally use one or two waveform drive rails to which individual inkjets are connected, generally through electronic selection circuitry, such as an application specific integrated circuit (ASIC), to fire ink drops towards a print medium. For the two-rail case, positive portions of waveforms are on a VPP drive rail while negative portions of the waveforms are on a VSS drive rail. A base capacitance on each of the drive rails, with no inkjets connected, is approximately 50 nF to 70 nF. Connecting one inkjet to a drive rail may add, for example, 55 pF additional capacitance, or a roughly 0.1% increase in capacitance.

The impedance measurement device 104 can be configured to measure an impedance of the piezoelectric actuators for each individual inkjet by measuring the additional capacitance of the piezoelectric actuator when connected to a drive rail and comparing it to a reference capacitance to determine the impedance and/or capacitance of each individual inkjet. The additional capacitance may be measured on either the VSS drive rail or the VPP drive rail. In the embodiments discussed below, the VPP drive rail is used for the measurements, but one of ordinary skill in the art would recognize the ability to do such measurements on the VSS drive rail as well, or on a single drive rail for print heads implementing only one waveform rail.

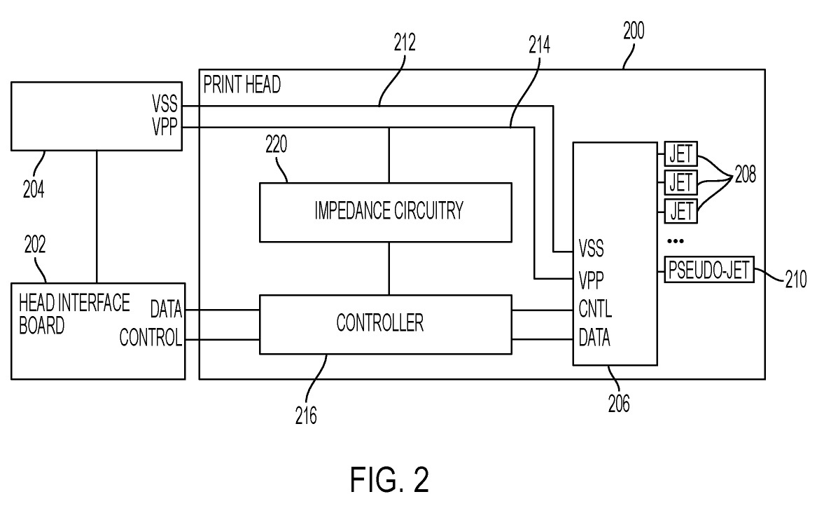

For example, with reference to FIG. 2, an exemplary block diagram of a printhead 200 is illustrated. The printhead 200 typically connects to external electronics, such as a printhead interface 202 electronically connected to a signal source 204. The external electronics provide image data to the printhead 200, along with waveform rails and associated timing and control signals. The printhead 200 includes electronic selection circuitry 206 which can selectively connect a piezoelectric actuator of an individual inkjet 208 and/or a pseudo-actuator 210 to the VSS drive rail 212 and/or the VPP drive rail 214. The pseudo-actuator 210, which also may be referred to herein as a pseudo-jet or dummy jet, may include, for example, a capacitor. During a normal print operation, the printhead interface 202 may instruct the signal source 204 to provide a waveform to the VSS drive rail 212 and the VPP drive rail 214 to drive the connected piezoelectric actuators of the various individual inkjets 208 to eject ink toward a print medium.

The printhead 200 also includes a controller 216, such as a field programmable gate array (FPGA), for receiving image data and timing signals from the printhead interface 202. The controller 216 is electronically connected to the electronic selection circuitry 206. The controller 216 can instruct the electronic selection circuitry 206 to connect either the various individual inkjets 208 or pseudo-actuator 210 to the drive rails 212 and 214, either for a print operation or for an impedance measurement, as will be discussed in more detail below.

As mentioned above, an impedance measurement for the piezoelectric actuators of each of the individual inkjets 208 can be performed over a sweep of frequencies to characterize jets and/or diagnose any issues with the jets. During an impedance measurement, the controller 216 sends instructions to the electronic selection circuitry 206 to connect a particular piezoelectric actuator of an individual jet 208, a pseudo-actuator 210, or no actuators (piezoelectric or pseudo) to the drive rails 212 and 214 to perform an impedance measurement. The pseudo-actuator 210 provides a reference capacitance for determining an impedance of each of the piezoelectric actuators of the individual jets 208 and no connected jets 208 or pseudo-actuators 210 provides a baseline reading.

The controller 216 outputs a digital signal to the impedance circuitry 220, which is used to measure the impedance on the VPP drive rail 214. In embodiments, the impedance circuitry 220 can be used to measure the impedance on the VPP drive rail 214. During normal printing, the impedance circuitry 220 may connect the external VPP waveform rail from the signal source 204 to the printhead’s internal VPP waveform rail 214 using, for example, a field effect transistor (FET). During impedance testing, the controller 216 may use the impedance circuitry 220 to disconnect the VPP waveform rail 214 from the external VPP rail signal source 204, which allows the VPP to be driven separately. In various embodiments, the impedance circuitry 220 can include various components, such as digital-to-analog converters (DACs), analog-to-digital converters (ADCs), capacitors, resistors, amplifiers, and/or the like.

In further embodiments, the impedance circuitry 220 may also include dedicated circuitry for detecting jet shorts. In such embodiments, a voltage pulse may be applied to each jet 208 one at a time. Current drawn by that one jet 208 is measured as is any current returning through all the other jets 208. If the driven jet 208 draws excess current, it is shorted. If that current returns through other jets, it is a jet-to-jet short. If the excess current does not show up in other jets, it is a jet-to-ground short. In embodiments, the jet shorts may be measured before the impedance measurements, and the shorted jets may be skipped during impedance measurement to avoid overloading the impedance circuitry 220. To indicate these types of faults, an artificial impedance value (which can be a hard-coded value outside the reasonably expectable impedance range) may be returned for these jets.

According to certain aspects of the present disclosure, additional details of the impedance circuitry is described in U.S. Patent No. 10,712,376, the contents of which are herein incorporated by reference in their entirety. As will be understood by one skilled in the art, the printhead 200 may also include various other components not discussed in further detail herein.

By performing impedance measurements of the inkjets 208 of each printhead 200 of a printing system (e.g., printing system 100), the printing system can confirm both electrical and mechanical operations of inkjets. For example, a poor connection, typically between the piezoelectric actuator and either the diaphragm layer below or a chip-on-flex (COF) contact above may also be identified using the impedance sweep. Such a poor connection would result in real capacitance starting low at a low frequency and dropping to almost zero at approximately 9 MHz. Loss, or an imaginary capacitance, starts high, peaks, and then drops along with the real capacitance at high frequencies. Parallel conductivity may be identified when capacitance starts on the higher side at low frequency, dropping to normal at higher frequencies, while the loss starts high and drops toward zero at higher frequencies. Parallel conductivity is typically caused by ink leaking into the piezoelectric area.

Turning to mechanical connections, a normal shaped capacitance sweep, but scaled down, may indicate that there is a cracked piezoelectric element not connected. Further, an impedance sweep having high capacitance across the frequency range may indicate a cracked or delaminated piezoelectric element. For a cracked or delaminated piezoelectric element, the mechanical resonances are of lower amplitude due to the inefficient electrical-to-mechanical coupling. Subtler piezoelectric cracks that do not show up as high capacitance may still be detected by changes in diaphragm resonances and piezoelectric element’s radial resonance.

Mechanical and fluidic resonances show up as peaks in the loss (imaginary) capacitance vs. frequency plots. Dry, pre-ink-filled, impedance sweeps show two primary resonances. The first primary resonance is the diaphragm drum-head resonance, which may be around 900 kHz, for example. The drum-head motion of the diaphragm approximates the motion used in jetting used to eject ink, that is, bending the diaphragm out of and into the body chamber of the print head. Changes in the frequency, width, and/or amplitude of the diaphragm resonance often correlate with changes in jetting performance, that is, the drive voltage required to eject drops.

The second primary resonance is controlled by the piezoelectric element itself, rather than by the diaphragm. The resonance amplitude is generally higher if the piezoelectric element is delaminated from the diaphragm since it is less constrained. Cracks may show up best on this resonance, especially combinations of vertical and horizontal cracks where no remaining piezoelectrical pieces have dimensions large enough to resonate at this second primary resonance. The secondary primary resonance remains largely unaffected by ink-fill, unlike the first primary resonance.

Fluidic resonances are present on filled printheads 200. With ink, the diaphragm resonance is gone. There is a low-amplitude, but important, low-frequency resonance called a Helmholtz resonance. It is sensitive to the entire single-jet fluid path from the orifice back. There is another resonance, around 500 kHz, for example, where gas bubbles within single-jet features generally shift this resonance higher or lower in frequency depending on the size and location of the bubble. Detecting bubbles by this frequency shift is perhaps the dominant use of the impedance measurement device 104.

As described herein, the printing system 100 can be configured to perform a battery of inkjet tests on the plurality of piezoelectric inkjets of one or more printheads. In particular embodiments, the battery of inkjet tests can include at least one of: (i) an impedance sweep test, (ii) a purge, wipe, analyze test, and/or (iii) a cap check test. The data output of each of these tests may vary, but in general, can be used to determine an inkjet status for each of the plurality of piezoelectric inkjets.

More specifically, the printer controller 107 of the printing system 100 may be further configured to analyze the data outputs of the battery of tests to determine the inkjet status of each piezoelectric inkjet of the one or more printheads 200, and to generate a visual diagnostic mapping of the non-functional inkjets. Additionally or alternatively, the printer controller 107 of the printing system 100 may be configured to transmit the data output of each of the tests to a remote management device 300 that is configured to analyze the data output to determine the inkjet status of each piezoelectric inkjet of the one or more printheads 200, take one or more remedial actions, and to generate a visual diagnostic mapping of the non-functional inkjets. In this manner, the printheads 200 of the printing system may be quickly and efficiently diagnosed locally (e.g., in-person) or remotely.

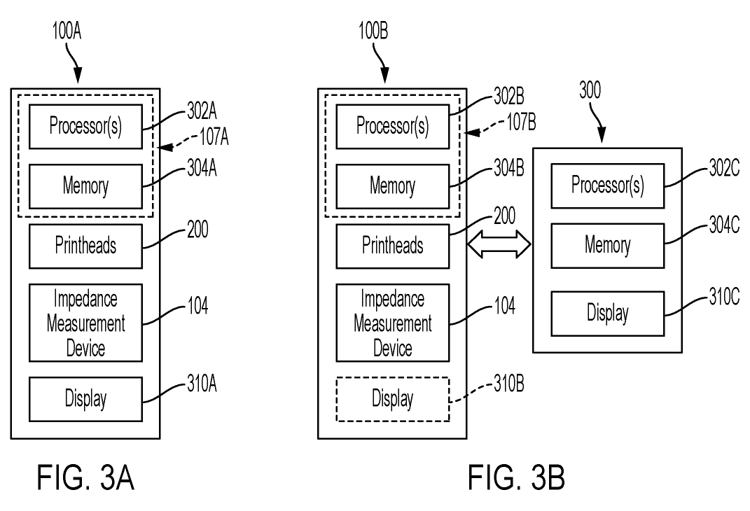

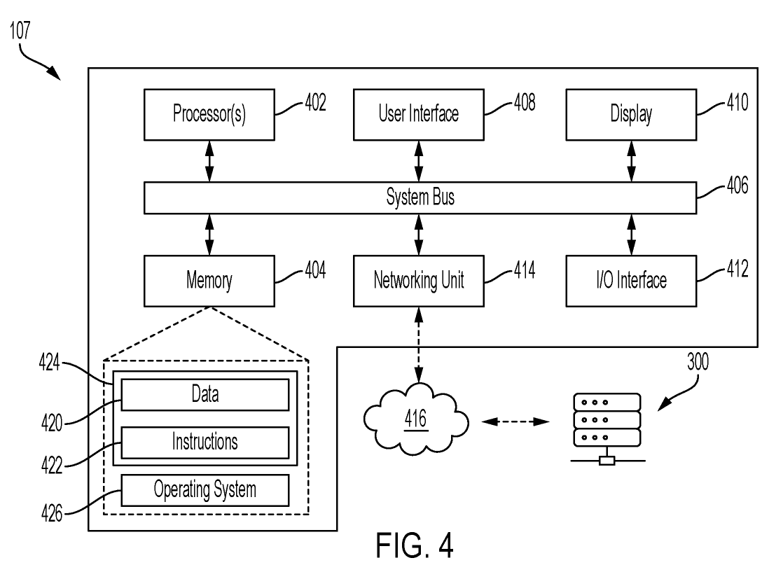

With reference to FIG. 3A, a first embodiment of a printing system 100A is illustrated wherein the printing system 100A is configured to diagnose one or more printheads 200 locally, while the example of FIG. 3B illustrates a second embodiment of a printing system 100B and remote management device 300 configured to remotely diagnose the one or more printheads 200.

Specifically, in the example of FIG. 3A, the printing system 100A includes: (i) a printer controller 107A comprising one or more processors 302A and a computer-readable memory 304A; (ii) one or more printheads 200; (iii) an impedance measurement device 104; and (iv) a display device 310A. According to this embodiment, the printer controller 107A can be configured to diagnose one or more printhead issues locally and to display a visual mapping of the problem jets using the display device 310A.

In the example of FIG. 3B, the printing system 100B includes: (i) a printer controller 107B comprising one or more processors 302B and a computer-readable memory 304B; (ii) one or more printheads 200; (iii) an impedance measurement device 104; and (iv) optionally, a display device 310B. According to this embodiment, the printer controller 107B can be configured to perform a battery of tests as described above, and to transmit the data output by those tests to a remote management device 300 via, for example, a wired and/or wireless communication network. The remote management device 300 may include one or more processors 302C, a computer-readable memory 304C, a display device 310C, and a networking unit (such as the networking 414 described below) that is configured to connect to one or more remotely located printing systems 100. The memory 304C can include computer-readable instructions that, when executed by the one or more processors 302C, cause the remote management device 300 to analyze the test data output received from the printing system 100B, determine a jet status for each of the piezoelectric inkjets, generate a visual mapping of the printing system 100B, and display the visual mapping via the display device 310C. In particular embodiments, the memory 304C can include computer-readable instructions that, when executed by the one or more processors 302C, cause the remote management device 300 to instruct the printing system 100B to perform the battery of tests.

In embodiments, the one or more processors 402 can include one or more high-speed data processors adequate to execute the program components described herein and/or perform one or more operations of the methods described herein. The one or more processors 402 may include a microprocessor, a multi-core processor, a multithreaded processor, an ultra-low voltage processor, an embedded processor, and/or the like, including combinations thereof. The one or more processors 402 can include multiple processor cores on a single die and/or may be a part of a system on a chip (SoC) in which the processor 402 and other components are formed into a single integrated circuit, or a single package. That is, the one or more processors 402 may be a single processor, multiple independent processors, or multiple processor cores on a single die.

In embodiments, the user interface 408 may be configured to receive various forms of input from a user associated with the printer controller 107. The user interface 408 can include, but is not limited to, one or more of a keyboard, keypad, trackpad, trackball(s), capacitive keyboard, controller (e.g., a gaming controller), computer mouse, computer stylus / pen, a voice input device, and/or the like, including combinations thereof.

In embodiments, the display device 410 may be configured to display information, including text, graphs, and/or the like. In particular embodiments, the display device 410 may be configured to display a visual mapping of one or more printheads 200. The display device 410 can include, but is not limited to, a liquid crystal display (LCD), a light-emitting diode (LED) display, a touch screen or other touch-enabled display, a foldable display, a projection display, and so on, or combinations thereof.

In embodiments, the input/output (I/O) interface 412 may be configured to connect and/or enable communication with one or more peripheral devices (not shown), including but not limited to additional machine-readable memory devices, diagnostic equipment, and other attachable devices. The I/O interface 412 may include one or more I/O ports that provide a physical connection to the one or more peripheral devices. In some embodiments, the I/O interface 412 may include one or more serial ports.

In embodiments, the networking unit 414 may include one or more types of networking interfaces that facilitate wired and/or wireless communication between the printer controller 107 and one or more external devices. That is, the networking unit 414 may operatively connect the printer controller 107 to one or more types of communications networks 416, which can include a direction interconnection, the Internet, a local area network (“LAN”), a metropolitan area network (“MAN”), a wide area network (“WAN”), a wired or Ethernet connection, a wireless connection, a cellular network, Bluetooth®, and similar types of communications networks, including combinations thereof. In some embodiments, the printer controller 107 may communicate with one or more remote / cloud-based servers and/or cloud-based services, such as remote server 418, via the communications network 416.

In embodiments, the memory 404 can be variously embodied in one or more forms of machine accessible and machine-readable memory. In some embodiments, the memory 404 can be a storage device including, but not limited to, a non-transitory storage medium, a magnetic disk storage, an optical disk storage, an array of storage devices, a solid-state memory device, and/or the like, as well as combinations thereof. The memory 404 may also include one or more other types of memory, such as dynamic random-access memory (DRAM), static random-access memory (SRAM), erasable programmable read-only memory (EPROM), electrically erasable programmable read-only memory (EEPROM), Flash memory, and/or the like, as well as combinations thereof. In embodiments, the memory 404 may include one or more types of transitory and/or non-transitory memory.

The printer controller 107 can be configured by software components stored in the memory 404 to perform one or more processes of the methods described herein. More specifically, the memory 404 can be configured to store data / information 420 and computer-readable instructions 422 that, when executed by the one or more processors 402, causes the printer controller 107 to analyze the data output from a battery of inkjet tests and generate a visual mapping of the printing system. Such data 420 and the computer-readable instructions 422 stored in the memory 404 may form a printhead self-sensing (PHSS) package 424 that may be incorporated into, loaded from, loaded onto, or otherwise operatively available to and from the printer controller 107. Thus, in some embodiments, the PHSS package 424 and/or one or more individual software packages may be stored in a local storage device of the memory 404. However, in other embodiments, the PHSS package 424 and/or one or more individual software packages may be loaded onto and/or updated from a remote server or service, such as server 418, via the communications network 416.

The printer controller 107 may also include an operating system component 426, which may be stored in the memory 404. The operating system component 426 may be an executable program facilitating the operation of the printer controller 107. Typically, the operating system component 426 can facilitate access of the I/O interface 412, network interface 414, the user interface 408, and the display 410, and can communicate or control other components of the printer controller 107.

Accordingly, provided herein is a computer program product 424 comprising a non-transitory computer-readable storage medium 404 having stored thereon computer-readable instructions 422 that, when executed by one or more processors (such as processors 402), cause the one or more processors to perform one or more operations of the methods described below.

Accordingly, the computer-readable storage medium 404 can include computer-readable instructions 422 that, when executed by one or more processors (such as processors 402), cause the one or more processors to perform a method for diagnosing one or more piezoelectric printheads of an inkjet printing system in accordance with the various aspects described herein.

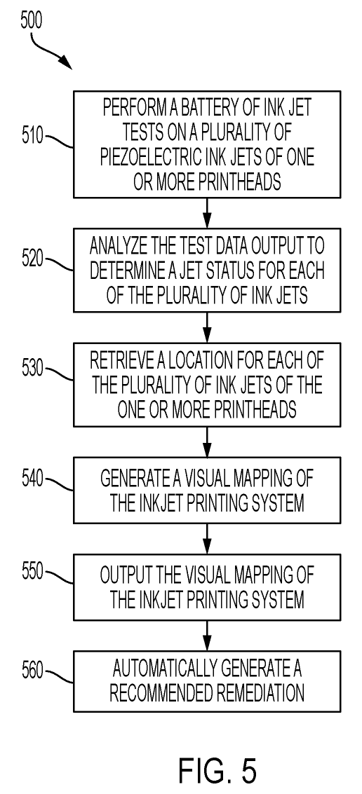

For example, with reference to FIG. 5, a method 500 for diagnosing one or more piezoelectric printheads of an inkjet printing system is illustrated in accordance with certain aspects of the present disclosure. As shown, the method 500 can include: in a step 510, performing or causing a printing system to perform a battery of inkjet tests on a plurality of piezoelectric inkjets of one or more piezoelectric printheads; in a step 520, analyzing the test data output to determine a jet status for each of the plurality of inkjets; in a step 530, retrieve a location for each of the plurality of inkjets of the one or more printheads; in a step 540, generate a visual mapping of the inkjet printing system; in a step 550, output the visual mapping of the inkjet printing system; and in a step 560, generate a recommended remediation.

More specifically, in the step 510, the method 500 can include performing or causing a printing system 100 to perform a battery of inkjet tests on a plurality of piezoelectric inkjets of one or more piezoelectric printheads 200. In some embodiments, the battery of inkjet tests may be initiated remotely by a remote management device 300 by instructing the printing systems (e.g., printing system 100B) to perform the battery of inkjet tests. In other embodiments, the battery of inkjet tests are initiated and performed by the printing system itself (e.g., printing system 100A). It should be appreciated that these embodiments are not mutually exclusive. That is, the printing system 100B may also be capable of locally initiating the battery of inkjet tests.

In embodiments, the battery of inkjet tests can include: (i) an impedance sweep test, (ii) a purge-wipe-analyze test, and/or (iii) a cap check test.

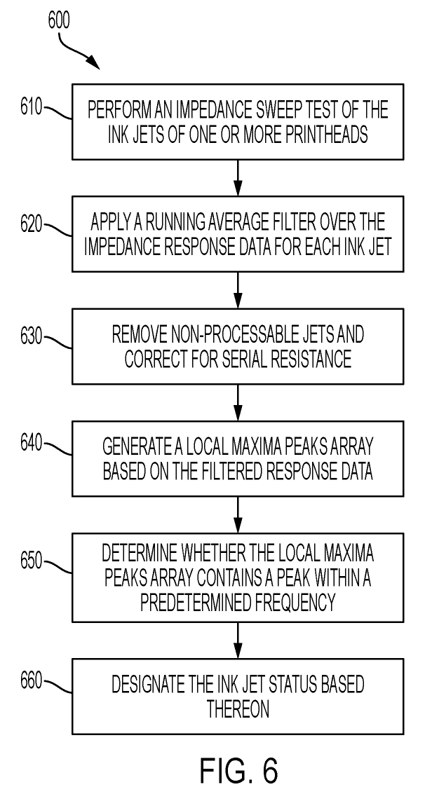

With reference to FIG. 6, a flowchart illustrating an impedance sweep test 600 is shown. As described above, the impedance sweep test 600 may include, in a step 610, measuring an impedance of the piezoelectric actuators for each individual inkjet of one or more printheads 200, which involves measuring the additional capacitance of the piezoelectric actuator when connected to a drive rail and comparing it to a reference capacitance to determine the impedance and/or capacitance of each individual inkjet. The measurements for each of the piezoelectric actuators of each of the individual inkjets 208 may be collected over a range of drive frequencies to characterize jets and/or diagnose any issues with the jets, typically ranging from about 64 kHz to about 1104 kHz. In particular embodiments, the impedance measurements may be taken within one or more sub-ranges at varying frequency steps, such as from about 64 kHz to about 84 kHz in increments of about 4 kHz, from about 86 kHz to about 108 kHz in increments of about 2 kHz, and about 144 kHz to about 1104 kHz in increments of 20 kHz. By doing so, detailed impedance response data for each piezoelectric inkjet can be collected in the step 610.

Although particular impedance sweep routines are disclosed, it should be appreciated that the sub-ranges tested as well as the increments and number of test points in each sub-range can be adjusted as needed for improved accuracy or improved speed. For example, in order to increase the speed of the testing protocol (i.e., reduce the amount of downtime needed to perform the protocol), the sub-ranges may be narrowed and/or the increments may be increased. In further examples, to improve the accuracy, the sub-ranges may be expanded and/or the increments may be reduced.

Once the impedance response data for one or more piezoelectric inkjets is collected, the impedance response data may be processed and analyzed on a jet-by-jet basis and certain failure modes may be identified for each of the inkjets. For example, in a step 620, a running average filter may be applied over the impedance response data for each piezoelectric inkjet one or more times to generate filtered impedance response data. The averaging window and the number of times the running average filter is applied may vary, but can be, for example, a three frequency wide centered averaging window that passes over each dataset five times recursively.

Next, in the step 630, one or more inkjets may be removed (i.e., disqualified) from further processing according to the impedance sweep test (although these jets may still be processed under one or more other tests). For example, in some embodiments, if a jet fails a cap check test or the impedance sweep data indicates a jet with parallel resistance, the jet will not be processed further according to the impedance sweep test.

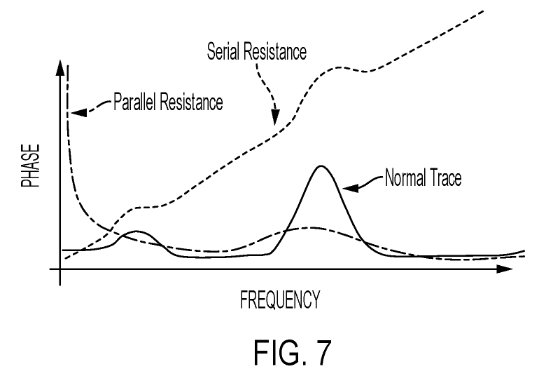

As shown in FIG. 7, the different impedance responses can be used to detect different problems / failure modes in inkjets. For example, as seen in the graph of FIG. 7, parallel resistance may be detected by first determining whether a slope of the filtered impedance response data within an initial low frequency range is too large of a negative value. That is, if the slope of the data within the initial measurement period is below a certain threshold (e.g., 0.0005), then that inkjet is designated as having parallel resistance is not processed further. Furthermore, a particular jet may also exhibit serial resistance. As shown in the graph of FIG. 7, this can be seen in the impedance response data. Inkjets with serial resistance may still be processed, but the linear trend may be pre-processed to de-slope the data before checking for peaks. In some embodiments, the data from a low frequency range (e.g., 224-464 kHz) and the data from a high frequency range (664-1064 kHz) are used to determine the slope.

Next, in the step 640, a local maxima peaks array is generated for each of the remaining jets based on the corresponding set of filtered impedance response data. This may be performed for each remaining jet by: (1) passing a frequency window over the filtered impedance response data; (2) determining a maximum value of the filtered impedance response data within each frequency window; and (3) for each frequency window: (i) determining whether each of the corresponding maximum value is located at a beginning or an end of the frequency window; and (ii) if the corresponding maximum value is not located at the beginning or the end of the frequency window, adding a frequency corresponding the maximum value to the local maxima peaks array for the piezoelectric inkjet.

In embodiments, the width of the moving frequency window may vary, but can be about 13 kHz. In further embodiments, the frequency corresponding to the maximum value is only added to the local maxima peaks array if the difference between the maximum and the average of the end points (defined by the window) is above a threshold value. In some embodiments, this threshold may be about 0.005.

Next, in the step 650, the local maxima peaks array for each of the inkjets is checked to determine whether the array includes a peak located within a predetermined frequency range as described in more detail below. In some embodiments, the peaks stored in the local maxima peaks array may be checked against multiple different frequency ranges.

In the step 660, the status of the inkjet is determined and designated based on whether the corresponding local maxima peaks array for the inkjet includes a peak located within one of these predetermined frequency ranges. For example, if piezoelectric inkjet has a peak located above 500 kHz, then the inkjet status may be designated as having a high frequency bubble. In further embodiments, if piezoelectric inkjet has a peak located below 500 kHz, then the inkjet status may be designated as having a low frequency bubble.

Returning to FIG. 5, the step 510 can also include performing: (ii) a purge-wipe-analyze test, and/or (iii) a cap check test. In embodiments, the purge-wipe-analyze test involves applying air pressure to the free surface of ink in an ink tank, which causes the pressure to be transferred through the ink lines and to the printhead causing ink to be forced out of the nozzles. The goal is to remove contaminants from the nozzles including dirt or debris, air bubbles, and partially-dried ink. The face of the printhead is then wiped to remove ink from the faceplate which may prevent the nozzles from jetting. During the analyze portion, a missing jet test target is printed. This print is then scanned with an image scanner (such as an image scanner of the printing system 100) and analyzed with software to determine which jets are printing a drop that meets specifications. Any jets that do not meet specifications are placed on a list of missing jets (i.e., non-responsive jets) and/or a list of off-axis jets. With respect to the off-axis jets, it should be appreciated that an off axis jet will have misplaced drops. Locations of printed drops can be lined up with a perfect grid of drops. The delta between where the drop was printed and the perfect grid is measured in two directions. Jets that are off more than a predetermined threshold (a certain number of microns) in the cross-process direction are considered badX jets and are included in the missing jet list. Jets may not be added to the list if they are misdirected in the process direction because they can be corrected for by adjusting the firing timing.

In further embodiments, the cap check test can include: (i) performing, using the impedance measurement device 104, an impedance measurement of each piezoelectric inkjet of the plurality of piezoelectric inkjets at a predetermined frequency to determine an impedance response for each piezoelectric inkjet; and (ii) designating the inkjet status of each piezoelectric inkjet based on the impedance response of the corresponding piezoelectric inkjet. In some embodiments, the inkjet status of a piezoelectric inkjet is designated as having a jet-to-ground short or a jet-to-jet short if the impedance response corresponds to a predefined artificial value hard-coded into the impedance measurement device. In further embodiments, the inkjet status of a piezoelectric inkjet is designated as being open if the impedance response of the piezoelectric inkjet is zero, or about zero, or within a predetermined range from zero.

As described herein, one or more of the (i) an impedance sweep test, (ii) a purge-wipe-analyze test, and/or (iii) a cap check test may be performed. In accordance with certain aspects of the present disclosure, all three of these tests may be performed in sequence. For example, in some embodiments, the step 510 of the method 500 includes first performing a purge-wipe-analyze test, then performing a cap check test, and then performing an impedance sweep test. However, it is contemplated that the order of these tests may be varied.

With further reference to FIG. 5, the method 500 can include, in a separate step 520, analyzing the test data output to determine a jet status for the plurality of inkjets of one or more printheads. That is, data generated by these tests may be analyzed and combined to determine an overall inkjet status. For example, after performing these tests, if a jet that was included in the missing jets list generated by the purge-wipe-analyze test is not designated a failure mode according to the cap check test or the impedance sweep test, then the status of the jet may be labeled as missing without a known cause. Any jets that were printing (i.e., not missing and/or off-axis) and not found to have any other failure modes may be labeled as good (i.e., nominally functional). It should be appreciated that the output data generated by performing the above-described tests may be analyzed by the printer controller 107 of the printing system 100 locally or may transmitted by the printing system 100 to a remote management device 300 to be remotely analyzed by the remote management device 300. Accordingly, the method 500 can include transmitting the test data output to the remote management device 300.

Next, in the step 530, the method 500 can include retrieving a location for each of the plurality of inkjets of the one or more printheads 200. In embodiments, the relative positions of each printhead 200 within the printing system 100 that the relative positions of each inkjet within each printhead 200 may be known and stored in a memory 304A, 304B, 400 (i.e., as data 420) of a printer controller 107 and/or the remote management device 300. Because printheads 200 will have a known size and layout of inkjets (this is required in order to properly form images on a print media), the locations retrieved according to this step can include the x and y coordinates of the corresponding inkjet.

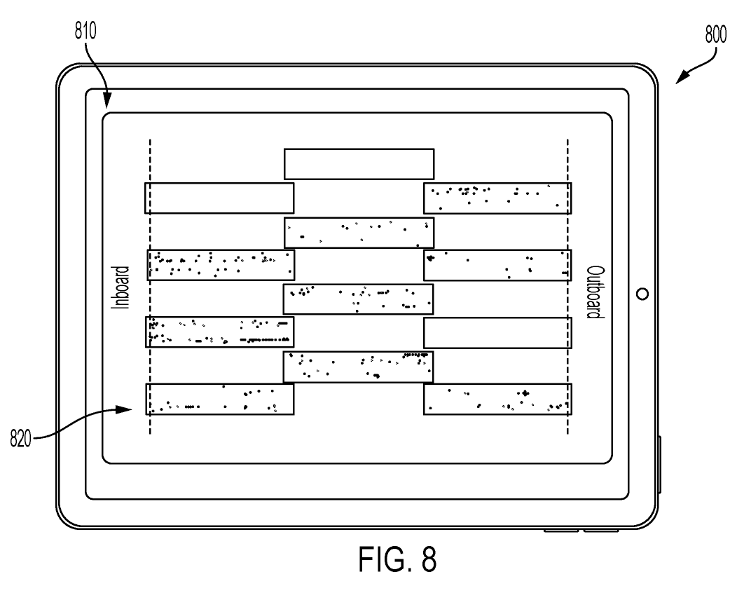

Next, in the steps 540 and 550, the method 500 can include generating a visual mapping of the inkjet printing system 100 based on the locations of the problem jets and the status of each corresponding jet, and then outputting the visual mapping via a display device. For example, with reference to FIG. 8, an electronic device 800 is illustrated having a display 810 showing a visual mapping 820 of an inkjet printing system 100 having 12 printheads 200 arranged in a known configuration (i.e., a known spatial location and arrangement). As shown, the visual mapping 820 includes 12 rectangles each representing a different printhead 200, and each dot represents the physical location in the printhead where a problem jet was identified.

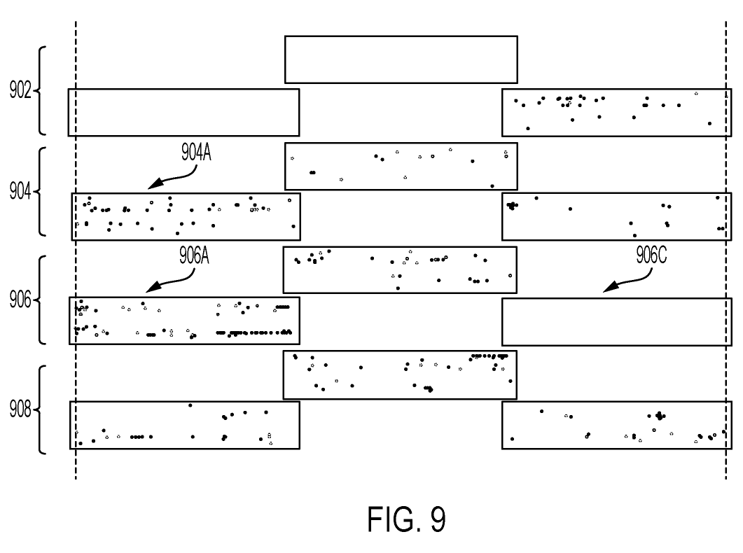

More specifically, as shown in FIG. 9, the visual mapping 820 includes four sets 902, 904, 906, 908 of three printheads 200, where each set corresponds to a particular ink color. In particular, the first set 902 includes three printheads 200 configured to eject yellow ink droplets, the second set 904 includes three printheads 200 configured to eject magenta ink droplets, the third set 906 includes three printheads 200 configured to eject cyan ink droplets, and the fourth set 908 includes three printheads 200 configured to eject black ink droplets. Although one particular configuration is illustrated, it should be appreciated that the systems and methods of the present disclosure can be equally applied to other printing system configurations (e.g., having different arrangements of a different number of printheads and printhead colors, etc.).

In the example of FIG. 9, some printheads such as the printheads 904A and 906A have a number of problem jets identified, whereas other printheads such as the printhead 906C have fewer or no problem jets identified. A quick inspection / analysis of this visual mapping 820 can therefore efficiently narrow down the sources of trouble within a printing system.

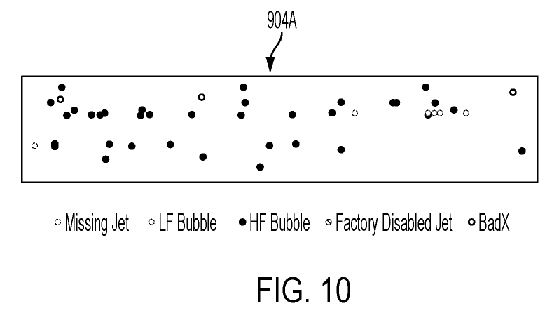

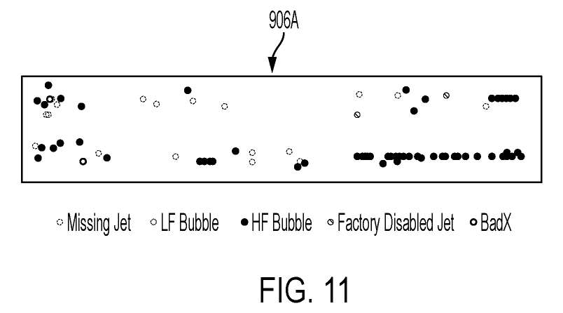

Furthermore, by examining each printhead 200 within the visual mapping 820 more closely, it can be determined whether and what types of remediations are appropriate. In particular, the visual mapping 820 may be customized so that each failure mode of the identified problem jets are easily distinguishable from one another. For example, as shown in FIG. 10 and FIG. 11, the printheads 904A and 906A are illustrated respectively, where distinguishing markings are used to identify a missing jet (without a known root cause), jets with low frequency bubbles, jets with high frequency bubbles, factory disabled jets (which are known prior to any testing and stored in the printhead itself), and BadX jets that are printing off-axis. Although certain failure modes are shown, it is contemplated that other types of failure modes and other types of markings may be used, for example, additionally markings for clogged jets or jets with parallel resistance or other electrical failures.

Finally, as shown in FIG. 5, the method 500 can include, in a step 560, generating a recommended remediation for the printing system 100. In embodiments, the recommended remediation may be generated based on a series of rules, which may account for the total number of missing jets with a particular status regardless of where the jets fall on a visual mapping. In further embodiments, the recommended remediation may also be generated based on the visual mapping 820 of the problem jets.

For example, different remediation routines may include: replacing one or more printheads; cleaning one or more printhead faceplates; performing a purging process that involves applying pressure to the ink tank to force ink through the printhead and out the inkjet nozzles to clear contaminants; running a bubble recovery routine that involves slowly passing freshly degassed ink past the air bubbles while sending a low voltage waveform to the piezoelectric actuator; looking for problems in another subsystem (e.g., if there are a lot of missing jets without a known cause, there may be a problem with the image scanner that is measuring missing jets or there may be physical damage to the printhead); if the missing jets for a cross-process line, the wiper blade should be inspected and/or replaced; and/or the like, including combinations thereof.

In particular embodiments, the recommended remediation may be automatically generated by the printing system 100 or by another system (e.g., a remote management system) based on the number of missing jets with a particular status, taking into account the physical location and distribution of the different errors, and/or based on the visual mapping.

As described above, each of the steps 520 through 560 may be performed either the printer controller 107 of a printing system 100 or by a remote management device 300, or some combination of the two.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

As used herein, although the terms first, second, third, etc. may be used herein to describe various elements or components, these elements or components should not be limited by these terms. These terms are only used to distinguish one element or component from another element or component. Thus, a first element or component discussed below could be termed a second element or component without departing from the teachings of the inventive concept.

Unless otherwise noted, when an element or component is said to be “connected to,” “coupled to,” or “adjacent to” another element or component, it will be understood that the element or component can be directly connected or coupled to the other element or component, or intervening elements or components may be present. That is, these and similar terms encompass cases where one or more intermediate elements or components may be employed to connect two elements or components. However, when an element or component is said to be “directly connected” to another element or component, this encompasses only cases where the two elements or components are connected to each other without any intermediate or intervening elements or components.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

It should also be understood that, unless clearly indicated to the contrary, in any methods claimed herein that include more than one step or act, the order of the steps or acts of the method is not necessarily limited to the order in which the steps or acts of the method are recited.

The above-described examples of the described subject matter can be implemented in any of numerous ways. For example, some aspects can be implemented using hardware, software or a combination thereof. When any aspect is implemented at least in part in software, the software code can be executed on any suitable processor or collection of processors, whether provided in a single device or computer or distributed among multiple devices/computers.

The present disclosure can be implemented as a system, a method, and/or a computer program product at any possible technical detail level of integration. The computer program product can include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium comprises the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, comprising an object oriented programming language such as Smalltalk, C++, or the like, and procedural programming languages, such as the “C” programming language or similar programming languages. The computer readable program instructions can execute entirely on the user’s computer, partly on the user’s computer, as a stand-alone software package, partly on the user’s computer and partly on a remote computer or entirely on the remote computer or server. In the latter scenario, the remote computer can be connected to the user's computer through any type of network, comprising a local area network (LAN) or a wide area network (WAN), or the connection can be made to an external computer (for example, through the Internet using an Internet Service Provider). In some examples, electronic circuitry comprising, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to examples of the disclosure. It will be understood that each block of the flowchart illustrations and/or block diagrams, and combinations of blocks in the flowchart illustrations and/or block diagrams, can be implemented by computer readable program instructions.

The computer readable program instructions can be provided to a processor of a, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture comprising instructions which implement aspects of the function/act specified in the flowchart and/or block diagram or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various examples of the present disclosure. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Other implementations are within the scope of the following claims and other claims to which the applicant can be entitled.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

What is claimed is:

1. An inkjet printing system comprising:
at least one printhead comprising a plurality of piezoelectric inkjets configured to eject ink droplets onto a print media substrate;
an impedance measurement device operatively connected to the at least one printhead and configured to measure an impedance response of each piezoelectric inkjet of the plurality of piezoelectric inkjets; and
a printer controller operatively connected to the at least one printhead and the impedance measurement device, wherein the printer controller comprises one or more processors in communication with a computer-readable storage medium having stored thereon instructions that, when executed by the one or more processors, cause the inkjet printing system to perform:
perform a battery of inkjet tests on the plurality of piezoelectric inkjets of the at least one printhead to determine an inkjet status for each of the plurality of piezoelectric inkjets, wherein the battery of inkjet tests includes at least one of: (i) an impedance sweep test, (ii) a purge, wipe, analyze test, and/or (iii) a cap check test.

2. The inkjet printing system of claim 1, wherein the computer-readable storage medium comprises instructions that, when executed by the one or more processors, cause the inkjet printing system to:
retrieve a location for each of the plurality of inkjets of the at least one printhead, wherein each location comprises x and y coordinates of the corresponding inkjet;
generate, based on the inkjet status and the location of each of the plurality of inkjets of the at least one printhead, a visual mapping of the inkjet printing system.

3. The inkjet printing system of claim 1, wherein the battery of inkjet tests includes the impedance sweep test, the impedance sweep test comprising:
performing, using the impedance measurement device, an impedance sweep of the plurality of piezoelectric inkjets to collect impedance response data for each piezoelectric inkjet, wherein the impedance sweep of the plurality of piezoelectric inkjets includes measuring an impedance response of each piezoelectric inkjet over a range of frequencies;
applying a running average filter over the impedance response data for each piezoelectric inkjet one or more times to generate a filtered impedance response data for each piezoelectric inkjet;
identifying, for each piezoelectric inkjet, a local maxima peaks array based on the filtered impedance response data for each corresponding piezoelectric inkjet;
determining, for each piezoelectric inkjet, whether the corresponding local maxima peaks array includes a peak located within a predetermined frequency range; and
designating the inkjet status of each piezoelectric inkjet having a peak located within the predetermined frequency range as having either a high frequency bubble or a low frequency bubble based on a frequency value of the peak located within the predetermined frequency range.

4. The inkjet printing system of claim 3, wherein the inkjet status of a piezoelectric inkjet having a peak located within the predetermined frequency range is designated as having a high frequency bubble if the frequency value of the peak located within the predetermined frequency range is greater than 500 kHz and
wherein the inkjet status of a piezoelectric inkjet having a peak located within the predetermined frequency range is designated as having a low frequency bubble if the frequency value of the peak located within the predetermined frequency range is less than or equal to 500 kHz.

5. The inkjet printing system of claim 3, wherein the local maxima peaks array is generated, for each piezoelectric inkjet, by:
passing a frequency window over the filtered impedance response data;
determining a maximum value of the filtered impedance response data within each frequency window;
for each frequency window: (i) determining whether each of the corresponding maximum value is located at a beginning or an end of the frequency window; and (ii) if the corresponding maximum value is not located at the beginning or the end of the frequency window, adding a frequency corresponding the maximum value to the local maxima peaks array for the piezoelectric inkjet.

6. The inkjet printing system of claim 5, wherein the frequency corresponding to the maximum value is only added to the local maxima peaks array only if the maximum value is greater than an average endpoints value for the corresponding frequency window by a predetermined threshold.

7. The inkjet printing system of claim 1, wherein the battery of inkjet tests includes the impedance sweep test, the impedance sweep test comprising:
performing, using the impedance measurement device, an impedance sweep of the plurality of piezoelectric inkjets to collect impedance response data for each piezoelectric inkjet;
applying a running average filter over the impedance response data for each piezoelectric inkjet one or more times to generate a filtered impedance response data for each piezoelectric inkjet;
for each piezoelectric inkjet, determining whether a slope of the filtered impedance response data within an initial period is less than a predetermined threshold; and
designating the inkjet status of each piezoelectric inkjet having a slope within the initial period that is less than the predetermined threshold as having parallel resistance.

8. The inkjet printing system of claim 1, wherein the battery of inkjet tests includes the cap check test, the cap check test comprising:
performing, using the impedance measurement device, an impedance measurement of each piezoelectric inkjet of the plurality of piezoelectric inkjets at a predetermined frequency to determine an impedance response for each piezoelectric inkjet;
designating the inkjet status of each piezoelectric inkjet based on the impedance response of the corresponding piezoelectric inkjet.

9. The inkjet printing system of claim 8, wherein the inkjet status of a piezoelectric inkjet is designated as having a jet-to-ground short or a jet-to-jet short if the impedance response of the piezoelectric inkjet corresponds to a predefined artificial value based on the cap check test.

10. The inkjet printing system of claim 9, wherein the impedance sweep test is skipped for any piezoelectric inkjets identified as having a jet-to-ground short or a jet-to-jet short according to the cap check test.

11. The inkjet printing system of claim 10, wherein the inkjet status of a piezoelectric inkjet is designated as being open if the impedance response of the piezoelectric inkjet is within a predetermined range from zero.

12. The inkjet printing system of claim 1, wherein the battery of inkjet tests includes the purge-wipe-analyze test, wherein the purge-wipe-analyze test generates a list of missing inkjets and a list of off-axis inkjets.

13. The inkjet printing system of claim 1, wherein the battery of inkjet tests includes:
performing the purge-wipe-analyze test to generate a list of missing inkjets and a list of off-axis inkjets;
performing the cap check test of a first set of one or more inkjets of the plurality of inkjets to determine an inkjet status for the one or more inkjets of the first set; and
performing the impedance sweep test of a second set of one or more inkjets of the plurality of inkjets to determine an inkjet status for the one or more inkjets of the second set.

14. A method of diagnosing a faulty printhead of an inkjet printing system, the method comprising:
performing a battery of inkjet tests on a plurality of piezoelectric inkjets of at least one printhead of the inkjet printing system to determine an inkjet status for each of the plurality of piezoelectric inkjets, wherein the battery of inkjet tests includes at least one of: (i) an impedance sweep test, (ii) a purge-wipe-analyze test, and/or (iii) a cap check test;
retrieving a location for each of the plurality of inkjets of the at least one printhead, wherein each location comprises x and y coordinates of the corresponding inkjet; and
generating, based on the inkjet status and the location of each of the plurality of inkjets of the at least one printhead, a visual mapping of the inkjet printing system.

15. The method of claim 14, wherein the impedance sweep test and the cap check test are performed by measuring an impedance response of the plurality of inkjets at one or more frequencies using an impedance measurement device operatively connected to the at least one printhead of the inkjet printing system.

16. The method of claim 14, wherein visual mapping identifies a spatial location of the at least one printhead, and the location of each non-functional inkjet of the plurality of inkjets is marked on the visual mapping of the inkjet printing system.

17. The method of claim 16, wherein the inkjet status of each non-functional inkjet indicates a failure mode of the non-functional inkjet, and the marking of each non-functional inkjet of the plurality of inkjets on the visual mapping is unique to the indicated failure mode.

18. The method of claim 16, further comprising:
displaying, on a display device, the visual mapping of the inkjet printing system.

19. The method of claim 16, further comprising:
automatically generating a recommended remediation based on the visual mapping of the inkjet printing system.

20. A remote management device configured to perform printhead self-sensing and diagnosis of one or more remotely located inkjet printing systems, the remote management device comprising:
one or more processors in communication with a non-transitory computer-readable storage medium having stored thereon instructions that, when executed by the one or more processors, cause the remote management device to perform:
connect, via a communication network, with a remotely located inkjet printing system, the inkjet printing system comprising (i) at least one printhead having a plurality of piezoelectric inkjets, and (ii) an impedance measurement device operatively connected to the at least one printhead; and
instruct the remotely located inkjet printing system to perform a battery of inkjet tests on the plurality of piezoelectric inkjets of the at least one printhead, wherein the battery of inkjet tests includes at least one of: (i) an impedance sweep test, (ii) a purge, wipe, analyze test, and/or (iii) a cap check test;
receive, from the remotely located inkjet printing system, test data output based on the battery of inkjet tests; and
analyze the test data output to determine an inkjet status for each of the plurality of piezoelectric inkjets.
